(19) United States
(12) Patent Application Publication
(10) Pub. No.: US 2020/0030750 A1
(43) Pub. Date: Jan. 30, 2020

(54) PROCESS FOR MANUFACTURING A MULTILAYER MEMBRANE ON A SOLID SUPPORT USING AN AMPHIPHILIC BLOCK COPOLYMER

(71) Applicants: CENTRE NATIONAL DE LA RECHERCHE SCIENTIFIQUE, PARIS (FR); UNIVERSITE DE BORDEAUX, BORDEAUX (FR); INSTITUT POLYTECHNIQUE DE BORDEAUX, TALENCE Cedex (FR)

(72) Inventors: Jean-Paul CHAPEL, BORDEAUX (FR); Christophe SCHATZ, AYGUEMORTE LES GRAVES (FR)

(21) Appl. No.: 16/475,815

(22) PCT Filed: Jan. 3, 2018
(86) PCT No.: PCT/FR2018/050005

§ 371 Date: Jul. 3, 2019

(30) Foreign Application Priority Data
Jan. 5, 2017 (FR) 1750095

(51) Int. Cl. B01D 67/00; B01D 69/10; B01D 71/80; B05D 1/18; B05D 1/36; B01D 69/12

(52) U.S. Cl. CPC B01D 67/0006; B01D 69/10; B01D 69/12; B05D 1/18; B05D 1/36; B01D 71/80

(57) ABSTRACT

Disclosed is a process for manufacturing a membrane from a, amphiphilic block copolymer including a hydrophilic block and a hydrophobic block including functions capable of forming a bond with the hydrophilic block in a bath containing the copolymer in solution in an apolar organic solvent, for a sufficient time to enable the formation of non-covalent bonds between the hydrophilic block and the support and the immobilisation of a first layer of the copolymer on the surface of the support; followed by adding water to the bath, so as to give rise to the self-assembly of a second layer of copolymer on the first layer.

### BACKGROUND OF THE INVENTION

### Field of the Invention

The present invention relates to a method for manufacturing a multilayer membrane supported on a solid surface, from one or more amphiphilic block copolymers. The invention also relates to a membrane obtainable by such a method.

### Description of the Related Art

Block copolymers constitute a class of materials with a self-assembly ability on a nanometric scale, which form at the present time ideal candidates for preparing organised thin films. These thin films find in particular an application for fields as varied as nanolithography, the synthesis of nanoparticles, optoelectronic devices, non-porous membranes, sensors, etc. It is also entirely advantageous for such films to be established on solid supports, which generally confer on them mechanical stability superior to that of vesicle membranes or self-supporting flat films. The solid support makes it possible in particular to preserve the structure of the film even after drying.

The best known methods of preparing organic thin films are spin coating, self-assembly of monolayers, grafting of polymers and assembly by the Langmuir-Blodgett technique.

The Langmuir-Blodgett technique is in particular one of the most efficient techniques at the present time for preparing ultra-fine multilayer membranes supported on a solid support, based on amphiphilic block copolymers. More particularly, homogeneous membranes based on amphiphilic block copolymers on a solid support can be prepared by the use consecutively of Langmuir-Blodgett and Langmuir-Shaefer techniques. In a first step, a functionalised amphiphilic block copolymer is attached physically, specifically or covalently to a substrate by the Langmuir-Blodgett technique. Then the substrate thus covered with the first layer of copolymer is placed on top of a Langmuir-Blodgett film and passed through an air/water interface, so as to transfer a second layer of copolymer onto the first layer. This method has the advantage of good control of the density of the layers.

However, this method is difficult to implement on an industrial scale, in particular because of the technical and economic difficulties that this implementation raises. It is moreover not applicable to all copolymers, or to all types of support, for example to hollow objects. It also does not make it possible to control the nanometric orientation of the copolymer blocks in the film.

Other methods for preparing membranes on a solid support, based on amphiphilic block copolymers, have been proposed by the prior art.

In this regard, mention can be made for example of the document WO 03/008646, which describes a method for forming a single-layer coating on a substrate such as a sensor, by self-assembly of surfactant multiblock molecules comprising a hydrophilic domain and a hydrophobic domain, such as an ethylene oxide and propylene oxide block copolymer, and then covalent fixing of this monolayer on the substrate, this fixing using specific reactive groups carried by the molecules.

The document WO 02/24792 for its part describes a method for preparing so-called self-assembled thin films by dipping a substrate in a dilute solution of a self-assemblable amphiphile, or exposure to a vapour phase containing the amphiphile, so that a single-layer organised molecular architecture forms spontaneously on the substrate. A precursor of the film is incorporated in an adhesive composition, so as to allow attachment to the substrate.

The document US 2014/099445 describes a method for preparing, on a substrate, a film nanostructured on the surface using an amphiphilic block copolymer, by putting a solution of the copolymer in contact with an organic solvent, optionally with water added, and deposition of this solution on the substrate in an atmosphere with a high level of humidity.

None of these methods however proves to be satisfactory for implementation on an industrial scale on all types of surface. The preparation of multilayer membranes, in particular dual layer, structured in their thickness, on a large scale, under conditions allowing control of the organisation and functionalities of the layers constituting the membrane, remains very difficult to obtain using amphiphilic block copolymers.

### SUMMARY OF THE INVENTION

The present invention aims to remedy the drawbacks of the methods for manufacturing membranes by self-assembly of an amphiphilic block copolymer proposed by the prior art, in particular the drawbacks disclosed above, by proposing such a method that makes it possible to prepare an organised ultra-thin membrane, supported on a solid support, with precise control of the thickness of the membrane and of the orientation of the copolymer blocks that constitute it on a nanometric scale, this method also being able to be implemented easily on an industrial scale.

The invention also aims for the method to be applicable: to a very wide variety of solid supports, in particular from the point of view of their shape and size, in particular to supports with a flat, curved, hollow, macroscopic or colloidal shape, and/or from the point of view of the material forming part thereof; and to a very wide variety of amphiphilic block copolymers, for example whatever the ratio by mass between the hydrophilic blocks and the hydrophobic blocks.

The invention also aims for this method to make it possible to form membranes having a structure that is either symmetrical or asymmetric, in particular to form asymmetric membranes composed of two different block copolymers, so as to confer a high degree of functionality on the membrane.

Supplementary objectives of the invention are that this method should be effective, ecological and economical to implement.

In the present description, amphiphilic block copolymer means any block copolymer wherein at least one block is hydrophilic and at least one block is hydrophobic.

Within the meaning of the present invention, the expression “block copolymer” encompasses block copolymers in a strict sense, that is to say copolymers comprising blocks of various compositions connected together in linear sequences, but also grafted copolymers, in which at least one block is connected laterally to the main chain, and the composition of which is different from that of this main chain, which constitutes another block of the copolymer.

Because of their particular structure, amphiphilic block copolymers adopt specific conformations in solution, in particular a micellar conformation.

Conventionally, it is also meant in the present description:
by hydrophilic block, a block of the copolymer soluble in water. The hydrophilic block may consist of a hydrophilic homopolymer, or a statistical copolymer containing one or more hydrophilic monomers;
by hydrophobic block, a block of the copolymer that is insoluble, or only slightly soluble, in water. The hydrophobic block may consist of a hydrophobic homopolymer, or a statistical copolymer containing one or more hydrophobic monomers.

Asymmetric membrane means a membrane having, on both faces, that is to say the so-called internal face thereof and the so-called external face thereof, copolymers with blocks with different chemical natures.

At the origin of the present invention, it was discovered by the inventors that it is possible to prepare ultra-thin membranes supported on a solid support from amphiphilic block copolymers, by a method in two phases, that can be implemented in situ, the first phase consisting of controlling/modulating the interactions between the support and one of the blocks of the copolymer in order to create a first monolayer of copolymer immobilised by strong interaction at the surface of the solid support, and the second phase consisting of triggering the self-assembly of a second monolayer of copolymer on the first monolayer, by switching the polarity of the solvent used, so as to form a membrane structure in a dual layer firmly immobilised on the solid support.

Thus the present inventors propose a method for manufacturing a membrane comprising at least two layers, from at least one amphiphilic block copolymer comprising at least one hydrophilic block and at least one hydrophobic block, referred to as the first amphiphilic block copolymer.

This method comprises successive steps of:

a) immersing a support comprising functions able to form a bond, in particular a non-covalent bond, with a hydrophilic block of the first amphiphilic block copolymer in a first bath containing said first amphiphilic block copolymer in solution in an organic solvent that is non-selective for said first amphiphilic block copolymer, in which said hydrophilic block and said hydrophobic block are soluble, this immersion being done for a sufficient period to enable the formation of bonds between said hydrophilic block and the support, and the immobilisation a first layer of the first amphiphilic block copolymer on the surface of the support;

b) when appropriate, when it is sought to form a membrane with an asymmetric structure, replacing the first bath with a second bath containing a second amphiphilic block copolymer comprising at least one hydrophilic block and at least one hydrophobic block, in solution in an organic solvent that is non-selective for said second amphiphilic block copolymer, in which the hydrophilic block and the hydrophobic block of the second amphiphilic block copolymer are soluble;

c) and adding water to the bath containing the support on the surface of which said first layer is immobilised, so as to cause, by hydrophobic effect, the self-assembly of a second layer of amphiphilic block copolymer on said first layer. Depending on whether intermediate step b) has or has not been implemented, this second layer is formed respectively by the second amphiphilic block copolymer or by the first amphiphilic block copolymer.

A solvent that is non-selective for a copolymer here means, conventionally per se, a solvent in which all the blocks constituting this copolymer are soluble.

Such a method is advantageously applicable to a great variety of amphiphilic block copolymers, and to all types of support, these supports being able to have any form, in particular a curved, hollow, spherical, macroscopic, porous and/or divided form, for example a nanoparticulate form, or a colloidal form, etc.

The method according to the invention applies in particular with success to any amphiphilic block copolymer that forms micelles in aqueous solution.

It is furthermore easy and inexpensive to implement, including on an industrial scale, and more environmentally friendly than the methods of the prior art. In particular it requires little energy, the various steps taking place without any temperature constraint, and preferably at ambient temperature and atmospheric pressure. It furthermore requires, as raw materials, only water, organic solvent, advantageously in a quantity below 1 litre per m² of membrane, and not much of the amphiphilic block copolymers, most generally a quantity of amphiphilic block copolymers not exceeding 30 mg/m² of membrane. The organic solvent can furthermore be recovered easily at the end of the method, recycled and reused.

The membrane obtained at the end of the method according to the invention can be used in a liquid solution or in air. In this regard, the method according to the invention may comprise a step of drying the membrane, such a step however not being obligatory.

The various steps of the method according to the invention can furthermore be carried out in situ. They allow a construction of the membrane layer by layer, so that it is possible to finely control the architecture of each of the layers, in particular the thickness thereof, and the molecular orientations within them, in particular the nanometric orientation of the copolymer blocks in the membrane, etc.

In particular, through a suitable choice of the amphiphilic block copolymer or copolymers, in particular of the nature (vitreous or rubber) of the hydrophobic block, of the molecular mass of the hydrophilic block and of the hydrophobic block and/or of the hydrophobicity of the hydrophobic block, and through a suitable choice of the solid support and of the solvents used, it is possible to control the adhesion of the membrane to the support, the cohesion, the thickness and the chemical affinity of the membrane, in particular of the hydrophobic reservoir that it forms, as well as its surface functionalities, with a view to subsequent interactions that it is intended to form in the context of the application thereof.

In the first step a), by virtue of the nature of the solvent used, advantageously no self-assembly of the first amphiphilic block copolymer takes place in the bath. The hydrophilic blocks of the molecules of the copolymer form bonds with the support, and spread over the surface of the latter, so as to form thereon a monolayer the characteristics of which can advantageously be controlled with precision through a suitable choice of the operating parameters. This monolayer is immobilised on the support. The hydrophobic blocks are then exposed on the surface of this monolayer.

The bonds formed between the hydrophilic blocks of the molecules of the first amphiphilic block copolymer and the support may be either covalent or non-covalent.

When it is wished to obtain a symmetrical membrane, in which the two layers have a similar constitution, the intermediate step b), of replacing the first bath with a second bath containing a different amphiphilic block copolymer, is not performed. The step c) of modifying the polarity of the medium by adding water is carried out directly in the first bath.

When it is wished to obtain an asymmetric membrane, the first layer and the second layer of which have different constitutions, the intermediate step b) is performed. In particular embodiments of the invention, an intermediate rinsing of the support on the surface of which the first layer is immobilised is then carried out, before it is immersed in the second bath.

In step c), a hydrophobic interaction between the hydrophobic blocks of the copolymers molecules is generated by the controlled addition of water in the organic medium, which has the effect of modifying the polarity of this medium. This advantageously, by hydrophobic effect, triggers the self-assembly of a second layer of copolymer on the first layer already immobilised on the support, and thereby the formation of a dual-layer membrane supported on the solid support.

The method according to the invention thus makes it possible to form ultra-thin dual-layer organic membranes, with a thickness that may be as low as 100 nm, and may even be less than 20 nm. By way of example, the method according to the invention makes it possible to form dual-layer membranes with a thickness of between 5 and 30 nm.

These membranes advantageously find an application in fields as diverse as electronics; optoelectronics; microfluidics; the field of sensors, whether it be vibration, image, medical, thermal solar, etc sensors; photonics; photovoltaics; plasmonics; catalysis; the textile, paint and ceramics fields; cosmetics; pharmaceuticals, in particular for administering drugs, or immobilising antigens or antibodies in the dual layer; medical diagnosis; etc.

In such fields, the membranes obtained by a method according to the present invention can for example be used for one of the following optional functions thereof, these functions being related to the structure of the amphiphilic block copolymer or copolymers that form them, and more particularly functionalities present on the surface thereof: wetting, corrosion inhibition, anti-UV radiation, amphiphobicity, impermeability, anti-dirt, anti-dust, hydrophobic self-cleaning, lubrication, adhesion, electrical insulation or electrical conductivity, immobilisation of biomolecules, mimes of cell membranes, biosensor, chemosensor, ability to immobilise nanoparticles on their surface (for preparing plasmon materials, catalysis), etc.

Such functions can be conferred on the membrane by the amphiphilic block copolymer or copolymers by themselves. For example, when the copolymer comprises a hydrophobic block of the polyethylene glycol type, this block, exposed on the surface of the membrane, confers on the latter an anti-adhesion function.

Otherwise, such functions may be provided by modifying the surface of the membrane, at the end or in the last step of the method according to the invention. Any modification method, in particular chemical, conventional per se for a person skilled in the art, can be used for this purpose.

Particular functions may also be provided for the membrane during manufacture thereof, by introducing into the first bath, for the step a) of immersion of the support in this first bath, one or more active agents that are then trapped in the membrane during self-assembly of the second layer on the first layer. The membrane then fulfils a role of hydrophobic reservoir for active agents, the properties of which can advantageously be taken advantage of for numerous applications. By way of example, fragrances, essential oils, nanoparticles such as gold nanoparticles, for example for photonic/plasmonic applications, may be included in this way in the membrane.

Each amphiphilic block copolymer used in the context of the invention may either be of the two-block type, that is to say a diblock copolymer, or of the three blocks type, that is to say a triblock copolymer (hydrophobic block-hydrophilic block-hydrophobic block, in which the hydrophobic blocks are identical or different; or hydrophilic block-hydrophobic block-hydrophilic block, in which the hydrophilic blocks are identical or different), or even more. It may have a linear, star or grafted architecture.

Different blocks means either blocks of different natures or blocks with the same nature and different molar masses.

The architecture of the first amphiphilic block copolymer, and if applicable the architecture of the second amphiphilic block copolymer, is preferably of the diblock type, that is to say comprising a hydrophilic block and a hydrophobic block, or of the triblock type.

Preferentially, the amphiphilic block copolymer or copolymers comprise a hydrophilic block that is relatively short compared with the hydrophobic block. For example, the amphiphilic block copolymer or copolymers may comprise a hydrophilic block with a degree of polymerisation of between 5 and 50, and a hydrophobic block with a degree of polymerisation of between 50 and 500.

In particular embodiments of the invention, which are however in no way limitative thereof, when the intermediate step b) is implemented, at least one hydrophobic block in the second amphiphilic block copolymer is identical to at least one hydrophobic block of the first amphiphilic block copolymer. The other blocks, both hydrophilic and hydrophobic, may be identical or different. The various amphiphilic block copolymers used may comprise the same number of blocks, or different numbers of blocks, and the same architecture, or different architectures.

In other particular embodiments of the invention, when the intermediate step b) is implemented, the second amphiphilic block copolymer and the first amphiphilic block copolymer comprise different hydrophobic blocks.

More generally, the first bath may contain a single amphiphilic block copolymer, or a plurality of such copolymers able to form a bond with the solid support. The second bath may also contain a single amphiphilic block copolymer, or a plurality of such copolymers.

It is within the capability of a person skilled in the art to determine, among all the existing polymers, which may constitute the hydrophilic blocks, and which may constitute the hydrophobic blocks, of the amphiphilic block copolymers according to the invention.

The hydrophobic block of the first amphiphilic block copolymer, and if applicable of the second amphiphilic block copolymer, is for example chosen from the group consisting of the following hydrophobic substances: hydrophobic polystyrenes, in particular non-substituted polystyrenes or the polystyrenes substituted by an alkyl group (such as polystyrene, poly(α-methylstyrene), polyacrylates (such as ethyl polyacrylate, n-butyl polyacrylate, tert-butyl polyacrylate, methyl polymethacrylate, alkyl polycyanoacrylate), polydienes (such as polybutadiene, polyisoprene, poly(1-4-cyclohexadiene)), polylactones (such as poly(ε-caprolactone), poly(δ-valerolactone), polylactides and polyglycolides (such as poly(L-lactide), poly(D-lactide), poly(D,L-lactide), polyglycolide, poly(lactide-co-glycolide)), polyolefins (such as polyethylene, poly(isobutylene)), polyoxiranes (such as polypropylene glycol, polybutylene glycol), polysiloxanes (such as poly (dimethylsiloxane), poly(diethylsiloxane), poly(methylsiloxane), polyethyl methyl siloxane), poly(ferrocenyl dimethylsilane)), polyacrylonitriles, polyvinyl acetates, poly(tetrahydrofuran), polyhydroxyalkanoates, polythiophenes, hydrophobic polypeptides (such as poly(γ-benzyl-L-glutamate), polyvaline, polyisoleucine, polymethionine), and polycarbonates (such as poly(trimethylene carbonate)), such a list being in no way limitative of the invention.

Preferentially, the amphiphilic block copolymer or copolymers used in the context of the invention comprise at least one hydrophobic block of the styrene or acrylate type. Such a hydrophobic block may for example be chosen from the hydrophobic polystyrenes such as atactic polystyrene (with a polydispersity index PDI<1.2), isotactic polystyrene, syndiotactic polystyrene, poly(4-acetoxy-styrene), poly(3-bromostyrene), poly(4-bromostyrene), poly(2-chlorostyrene), poly(3-chlorostyrene), poly(4-chlorostyrene), poly(pentafluorostyrene), poly(4-dimethylsilyl-styrene), poly(4-hydroxy-styrene), poly(4-methoxy-styrene), poly(4-methyl-styrene), poly(4-t-butyl-styrene), poly(4-(tert-butoxycarbonyl) oxy-styrene), poly(3-(hexafluoro-2-hydroxypropyl)-styrene), poly(benzyl vinyl chloride), poly(4-vinyl benzoic acid), poly(4-vinyl benzoic acid, tert-butyl ester), poly(4-cyano-styrene), poly(4-[N,N-bis(trimethylsilyl-amino-methyl]styrene), poly(methyl 4-vinyl benzoate); or among the polyacrylates such as poly(benzyl α-ethyl acrylate), poly(benzyl α-propyl acrylate), poly(cyclohexyl acrylate), poly(cyclohexyl methacrylate), poly(isopropyl acrylate), poly(ethyl methacrylate), poly(ethyl α-ethyl acrylate), poly(ethyl α-propyl acrylate), poly(glycidyl methacrylate), poly(hydroxypropyl acrylate), poly(isobornyl methacrylate), poly(isobutyl methacrylate), poly(lauryl methacrylate), poly(methyl acrylate), poly(methyl α-bromoacrylate), poly(N,N-dimethylaminoethyl methacrylate), poly(2,2,2-trifluoroethyl methacrylate), poly(n-butyl methacrylate), poly(neopentyl methacrylate), poly(neopentyl acrylate), poly(n-hexyl methacrylate), poly(n-nonyl acrylate), poly(n-nonyl methacrylate), poly(n-octyl acrylate), poly(n-propyl methacrylate), poly(octadecyl methacrylate), poly(sec-butyl methacrylate), poly(tert-butyl α-ethylacrylate), poly(α-propyl tert-butyl acrylate), poly(tetrahydrofurfanyl methacrylate), poly(methyl 2,4-dimethylpenta-2,4-dienoate), poly(2-ethyl hexyl acrylate), poly(l-adamantyl methacrylate), poly(2-hydroxypropyl methacrylate), etc.

The hydrophilic block of the first amphiphilic block copolymer, and if applicable the hydrophilic block of the second amphiphilic block copolymer, is for example chosen from the group consisting of the following hydrophilic substances: polyacrylic acids (such as polyacrylic acid, polymethacrylic acid, polyethylacrylic acid), polyacrylamides (such as polyacrylamide, polydimethylacrylamide, poly(N-isopropyl acrylamide)), polyethers, such as polyethylene oxide or polyethylene glycol, poly(methyl vinyl ether)), polystyrene sulfonic acids, polyvinyl alcohols, poly(2-vinyl N-methyl pyridinium), poly(4-vinyl N-methyl pyridinium), polyamines, hydrophilic polypeptides (such as polylysine, polyhistidine, polyarginine, poly(glutamic acid), poly(aspartic acid)), polyoxazolines (such as poly(2-methyl-2-oxazoline)), polysaccharides (such as chitosan, alginate, hyaluronan, carrageenan, pectin, dextran, dextran sulfate, amylose, xylane, xyloglucan, beta glucans, fucans, polysialic acid, cellulose oligomers), polyureas, zwitterionic polymers (such as poly(sulfobetaines) and poly(carboxybetaines)), or any of the salts thereof, such a list being in no way limitative of the invention.

The amphiphilic block copolymers formed with the hydrophobic blocks listed above, and the hydrophilic blocks listed above, form micelles in an aqueous solution.

The support used is a solid support, comprising functions able to form covalent or non-covalent bonds with a hydrophilic block of the first amphiphilic block copolymer used for forming the first layer in step a) of the method according to the invention. Such non-covalent bonds may be of any type. They may in particular be hydrogen bonds, electrostatic interactions, van der Waals interactions, charge-transfer interactions, or specific interactions such as interactions between the complementary bases of DNA for example.

The support may be formed from any material not able to be dissolved by the organic solvent or solvents forming part of the first bath, and if applicable of the second bath.

The support may for example be formed from a material chosen from ceramics, glasses, silicates, polymers, graphite and metals.

The support may have any form, in particular a planar form, a dispersed form, such as a particle, nanoparticle, tube or leaf form, a hollow or mesoporous form, etc.

For example, the support may have a planar or hollow form, preferably a planar form, and be formed from silica, silicon, mica, gold, silver or a polymer material such as polyethylene, polyethylene terephthalate or polymethyl methacrylate, when appropriate previously surface functionalised. It may otherwise be in the form of organic micro- or nanoparticles, for example in latex or carbon nanotubes, or inorganic, for example in silicon dioxide SiO₂, cerium oxide CeO₂, iron tetroxide Fe₃O₄, iron oxide Fe₂O₃, silver, gold, etc. The method according to the invention may also use, as a solid support, bulky molecules such as dendrimers.

The method according to the invention may comprise a prior step of modification of the surface of the support in order to form on its surface functions able to form bonds, covalent or non-covalent, with a hydrophilic block of the first amphiphilic block copolymer.

Such a surface modification may be of any type conventional per se for a person skilled in the art. For example, it may consist of a physical treatment such as a plasma treatment, the absorption of charged polymers, such as polyelectrolytes, or a chemical grafting introducing reactive functions of the alcohol, acid, amine, silane, thiol, etc type.

For example, the method according to the invention may comprise a prior step of amination of the surface of a silica support, by electrostatic adsorption of a polyamine, such as polylysine, poly(allylamine) or polyethyleneimine, preferably at a pH lower than the pKa thereof. The silica support modified on the surface by amine groups can then interact with a polyacid block, for example in tetrahydrofuran, by a simple acid/base neutralisation generating pairs of strong-interaction ions (—COO⁻, —NH₃⁺).

Other intermolecular forces, such as hydrogen bonds, may be used for immobilising the first layer of the membrane on the solid support, for example to allow the bonding of a block (polyethylene oxide) with silanol groups formed on the surface of a silica support.

Examples of hydrophilic block/solid support pairs able to be used in the context of the invention are for example, non-limitatively: polyethylene glycol block/silica support; polyacrylic acid block/aminated silica support; poly(2-vinyl N-methyl pyridinium) block/carboxylated silica support; poly(3-hexylthiophene) block/gold support.

The organic solvent of the first bath, and if applicable the organic solvent of the second bath, is chosen according to the particular amphiphilic block copolymer used in the bath, so as to ensure good solubilisation of this copolymer.

This solvent is non-selective for the associated hydrophilic block copolymer, that is to say all the blocks of the block copolymer have good solubility therein.

The organic solvent of the first bath, and if applicable the organic solvent of the second bath, is preferentially chosen from the group consisting of tetrahydrofuran, dimethylsulfoxide, dimethylformamide, dimethylacetamide, acetonitrile, dioxane, acetone, ethylene glycol, methanol, pyridine, N-methyl-2-pyrrolidone, toluene, xylene, dichloromethane, chloroform, hexafluoroisopropanol, or any one of the mixtures thereof.

In general terms, in the present description, the term solvent means both single solvents and mixtures of solvents.

The organic solvent used in the first bath, and if applicable in the second bath, is preferably a water-miscible solvent.

For implementation of step a), and when appropriate of step b), the first bath, and when appropriate the second bath, are of course devoid of water.

The method according to the invention may furthermore meet one or more of the features described below, implemented alone or in each of the technically operative combinations thereof.

In particular embodiments of the invention, the method comprises, after the step c) of adding water to the bath, said addition of water causing the self-assembly according to a controlled architecture of a second amphiphilic block copolymer layer on said first layer, a step d) of rinsing the support and amphiphilic block copolymer layers with an aqueous solution. Such a rinsing step advantageously makes it possible to eliminate the micelles or vesicles formed by the amphiphilic block copolymer during the implementation of the method according to the invention, which are free in the bath. During such a step, the two amphiphilic block copolymer layers forming the membrane remain immobilised on the support.

Preferably, the rinsing step d) comprises the gradual replacement of the organic solvent contained in the bath with water.

Such a replacement can in particular be achieved by introducing water in liquid form into the bath, and concomitant aspiration of the liquid contained in the bath above the membrane immobilised on the support, until the whole of the organic solvent has been replaced with water. Then a water/air interface is created in the reservoir containing the bath, which advantageously avoids the destructuring of the membrane when it comes into contact with air, when it is removed from the bath.

The various operating parameters of this rinsing step, in particular the rate of introduction of the rinsing water into the bath, and the rate of aspiration of the liquid, are preferably chosen according in particular to the volume of the bath used, so that the complete replacement of the organic solvent with water is carried out in a time that may range from a few minutes to a few hours.

In particular embodiments of the invention, the rate of introducing the rinsing water into the bath and the rate of aspiration of the liquid are chosen so that the volume of liquid in the bath remains constant throughout the rinsing step d).

When all the solution has been exchanged with water, the membrane and its support are removed from the bath.

The method according to the invention can then, optionally, comprise a final step of rinsing the membrane thus obtained.

The organic solvent eliminated from the bath gradually, by exchange with the water, can advantageously be recovered and recycled, according to any method conventional in itself.

Preferentially, the volume of the bath for implementing the step c) of adding water into the bath is small, while nevertheless ensuring that the support on the surface of which the first layer is immobilised is entirely immersed in the bath. Such a feature minimises the phenomenon of self-assembly of the amphiphilic block copolymer in solution, in favour of the self-assembly of a second layer on the first layer immobilised on the solid support.

More particularly, for implementation of the step c) of adding water into the bath, the height of the liquid above the support on the surface of which a first copolymer layer is immobilised is preferentially small, and in particular less than 5 mm, and for example approximately 1 mm. Such a feature makes it possible to minimise firstly the cost of reagents of the method and secondly the phenomenon of self-assembly in solution.

In particular embodiments of the invention, the step c) of adding water to the bath comprises the gradual introduction of a liquid aqueous solution into said bath. Such an embodiment proves to be particularly appropriate when the bath in which the support carrying the first amphiphilic block copolymer layer is immersed contains a water-miscible solvent. It allows a gradual change in polarity of the bath.

The aqueous solution may be water, a dilute acid solution, a dilute base solution, or an acid or alkaline buffer. It may furthermore contain salts.

The method according to the invention may comprise a concomitant step of bubbling carbon dioxide in the bath, so as to reduce the pH of the bath and to provide a finer modulation of the self-assembly of the second layer on the first layer of the membrane, in particular when the hydrophilic block is a polyamine.

Preferentially, the aqueous solution is added to the bath at a distance from the support, so that it reaches the first layer immobilised on the support by diffusing, rather than convectively. The self-assembly of the second layer on the first layer then takes place in a pseudo-equilibrium state, so that the second layer is particularly homogeneous.

In particular embodiments of the invention, the gradual introduction of the liquid aqueous solution in the bath, at step c), is carried out at a rate making it possible to obtain an increase in the quantity of water in the bath that is less than or equal to 50%, preferably less than or equal to 20% by volume, with respect to the total volume of the bath, per minute. More particularly, this rate is chosen so as to be placed under conditions of thermodynamic equilibrium for the self-assembly, that is to say conditions in which there is equilibrium between the copolymer molecules in solution and the copolymer molecules assembled in the second layer of the membrane. This state of equilibrium makes it possible to obtain better structural organisation of the membrane.

The gradual introduction of the liquid aqueous solution into the bath is preferably carried out until it is obtained a quantity of water in the bath of between 5% and 50%, preferably between 3% and 30%, by volume, with respect to the total volume of the bath, preferably approximately equal to 10% by volume with respect to the total volume of the bath.

Step d) of rinsing the membrane can then be implemented, as described above.

In the particular embodiments of the invention in which the step c) of adding water to the bath comprises the gradual introduction of a liquid aqueous solution therein, the step c) of adding water into the bath and the rinsing step d) form in practice a single step, during which water is added to the bath, initially in small quantities, and then the proportion of water in the bath is increased while implementing the concomitant aspiration of liquid contained in the bath.

In alternative embodiments of the invention, particularly suitable for the cases where the organic solvent used in the bath, at step c) of adding water to the bath, is a solvent that is not or is only slightly miscible with water, this step c) comprises putting the bath in contact with saturated water vapour.

This putting in contact is preferably carried out by saturation of the atmosphere above the bath with water vapour, and preferentially for a period of between 10 and 180 minutes, for example between 10 and 90 minutes. The water molecules then partly solubilise in the solvent and cause a solvent/water switching in the bath and the change of polarity of the bath, which triggers the self-assembly of the amphiphilic block copolymer present in the bath and of the amphiphilic block copolymer forming the first layer immobilised on the support (these copolymers may be identical or different).

In particular embodiments of the invention, in step a), the immersion of the support in the first bath is carried out for a period of between 10 and 180 minutes, for example for approximately 2 hours. Such a period advantageously ensures the formation, in the bath, of bonds immobilising the molecules of the first amphiphilic block copolymer, more precisely by means of the hydrophilic block, on the surface of the support.

In particular embodiments of the invention, the first bath contains the first amphiphilic block copolymer at a concentration of between 0.01 and 10 g/l, preferably between 0.1 and 1 g/l, in the organic solvent.

Preferentially, when it is used, if it is wished to form an asymmetric membrane, the second bath contains the second amphiphilic block copolymer at a concentration of between 0.01 and 10 g/l, preferably between 0.1 and 1 g/l, in the organic solvent.

The volume of the first bath, for implementing step a), is furthermore preferentially small. For example, the height of liquid above the surface of the solid support is between 1 and 5 mm.

Step a) may furthermore be carried out under inert atmosphere, for example under nitrogen or argon.

The method according to the invention, as described above, comprising steps a) of forming the first layer on the support, when appropriate b) of replacing the bath, and c) of forming the second layer by self-assembly on the first layer, makes it possible to obtain a dual-layer membrane.

Steps a), when appropriate b) and optionally c) may be reiterated in order to form additional layers on the two layers already immobilised on the support, so as to obtain a multilayer membrane comprising a number of layers greater than two. The method then comprises, before reiteration of step a) of immersing the support in the bath, a step of stabilising the first dual-layer formed, for example by covering this dual layer of polymer or particles able to protect its surface, or by crosslinking its hydrophobic blocks, in order to prevent dissociation of this first dual layer when it is immersed in the first bath of the following step a).

Optionally, the method may also comprise, before reiteration of the step a) of immersion of this support in the bath, a step of rinsing the support and/or a step of functionalisation of the first dual layer, in order to introduce on its surface functions able to form, in a non-polar environment, covalent bonds or non-covalent interactions with the amphiphilic block copolymer intended to constitute the following layer.

The new steps a), b) and c) may be carried out with the same amphiphilic block copolymers as the first steps a), b) and c), or with different amphiphilic block copolymers.

The steps of the method according to the invention may thus advantageously be reiterated as many times as necessary for preparing the membrane comprising the total number of layers required.

Another aspect of the invention relates to a membrane obtainable by a method according to the invention. This membrane, which is structured in its thickness, comprises a first layer of an amphiphilic block copolymer immobilised on a support, in particular by non-covalent bonds, and a second layer of an amphiphilic block copolymer fixed to the first layer by hydrophobic interaction.

In this membrane, the surface of the second layer is more hydrophilic than the first layer immobilised on the support. Such a feature may in particular be checked by measurements of contact angles, according to a technique that is conventional in itself for a person skilled in the art.

The amphiphilic block copolymer of the first layer and the amphiphilic block copolymer of the second layer may be identical or different. In the latter case, they may comprise at least one identical hydrophobic block.

The amphiphilic block copolymer or copolymers and the support may comply with one or more of the features described above with reference to the method for manufacturing a membrane according to the invention.

The membrane has in particular a thickness of less than or equal to 100 nm, for example less than or equal to 50 nm or less than or equal to 20 nm. It has for example a thickness of between 5 and 30 nm. This thickness can be controlled, and is directly related to the size of the blocks of the amphiphilic block copolymers that make up the membrane, these blocks being disposed with respect to each other in an organised fashion.

It may comprise two layers or more.

### BRIEF DESCRIPTION OF THE DRAWINGS

The features and advantages of the invention will emerge more clearly in the light of the example embodiments below, provided simply for illustration and in no way limitatively of the invention, with the support of FIGS. 1 to 7, in which:

FIG. 1 shows schematically the various steps of manufacturing a dual-layer membrane from an amphiphilic block copolymer by the use of a method according to the invention;

FIG. 2 shows the results obtained for the analysis of a monolayer of PS-b-PAA formed in accordance with the invention on a silicon support, a) by quartz crystal microbalance with dissipation, in the form of a graph showing the quantity of copolymer adsorbed Γ according to the concentration of copolymer in the first bath; b) by atomic force microscopy (AFM); c) in the form of a graph showing the distribution of the heights determined using AFM analysis;

FIG. 3 shows the results obtained for the analysis of a symmetrical dual layer of PS-b-PAA formed in accordance with the invention on a silicon support, a) by quartz crystal microbalance with dissipation, in the form of a graph showing the quantity of copolymer adsorbed δ as a function of the reaction time; b) by atomic force microscopy (AFM); FIG. 3a) shows schematically the solid support and the layer or layers of copolymer immobilised on its surface, for each step of the method and the corresponding reaction time;

FIG. 4 shows atomic force microscopy images of a monolayer of PS-b-POE formed in accordance with the invention on a silicon support, a) 5×5 μm², b) 1×1 μm²;

FIG. 5 shows the results obtained for the analysis of an asymmetric dual layer PS-b-PAA and PS-b-POE formed in accordance with the invention on a silicon support, a) by atomic force microscopy (AFM); b) in the form of a graph showing the distribution of the heights obtained using AFM analysis;

FIG. 6 shows schematically a dual-layer membrane encapsulating nanoparticles, obtained from an amphiphilic block copolymer by the use of a method according to the invention;

FIG. 7 shows spectra obtained by transmission UV-visible spectroscopy, respectively for a dual-layer membrane encapsulating gold nanoparticles obtained by a method according to the present invention (continuous curve) and for gold nanoparticles in solution in a mixture of tetrahydrofuran and dimethylformamide (broken-line curve).

### DESCRIPTION OF THE PREFERRED EMBODIMENTS

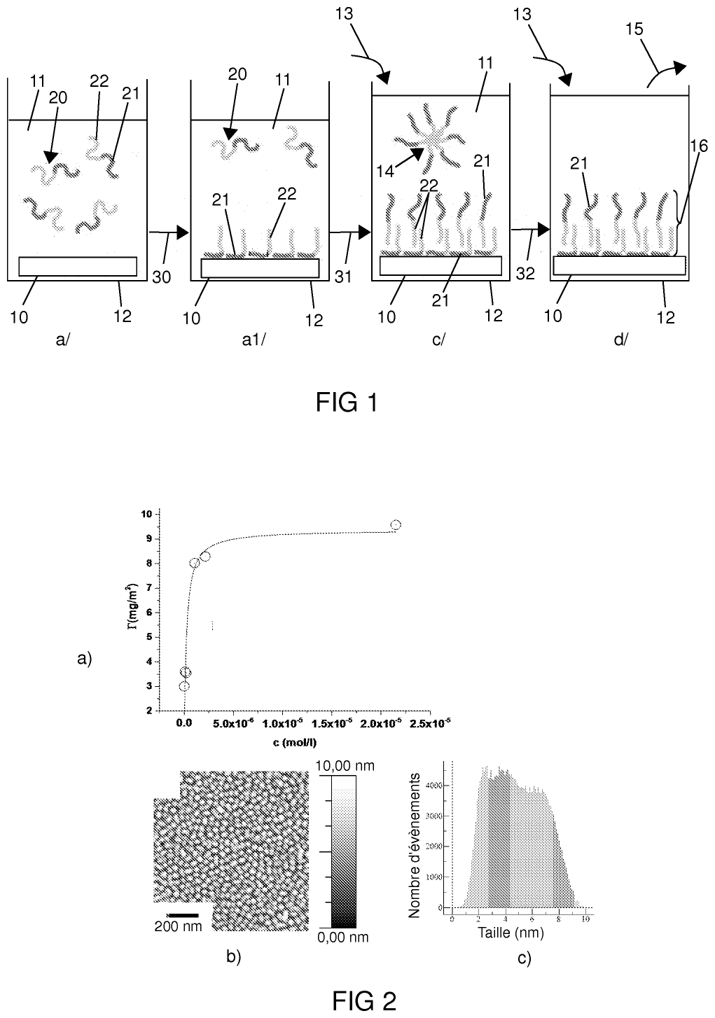

The various steps for forming, on a solid support 10, a dual-layer membrane based on an amphiphilic block copolymer 20, by implementing a method according to the present invention, are illustrated schematically in FIG. 1.

In the embodiment shown in this figure, the solid support is a flat plate. The method according to the invention is advantageously applicable in a similar manner to supports of any other form.

The solid support 10 carries on its surface functions able to form bonds with the amphiphilic block copolymer 20. In the following description, the example of non-covalent bonds will be taken, this naturally being in no way limitative of the invention.

In a first step a), the solid support 10 is immersed in a bath 11 comprising an amphiphilic block copolymer 20 in solution in an organic solvent.

The amphiphilic block copolymer 20 comprises at least one hydrophilic block 21 and at least one hydrophobic block 22. In the particular embodiment illustrated in FIG. 1, it is a diblock copolymer comprising one hydrophilic block and one hydrophobic block. The invention applies in a similar manner to any other type of block copolymer, in particular, but non-limitatively, to triblock copolymers.

The solvent used is a solvent with a polarity lower than that of water, non-selective for the copolymer, in which the two blocks are well solvated, or a mixture of solvents having such properties.

Putting the solid 10 in contact with the bath 11 of copolymer 20, under such conditions, gives rise, as illustrated at 30 in FIG. 1, at step al), to the formation of non-covalent bonds between the solid support 10 and the hydrophilic block 21 of the copolymer. In this way a monolayer formed from hydrophilic blocks 21 is formed on the solid support 10. The hydrophobic blocks 22 for their part extend from this monolayer, probably in a comb configuration.

A few copolymer molecules 20 remain free in solution.

As illustrated at 31 in FIG. 1, in the following step c), water is added to the bath 11.

When the solvent used is a water-miscible solvent, this is achieved by the gradual addition of a liquid aqueous solution to the bath 11, as indicated at 13 in FIG. 1. The addition is preferably carried out under conditions as close as possible to pseudo-equilibrium conditions. Thus the aqueous solution is preferably added very gently, at a rate of a few hundreds of microlitres per minute, and in a region of the reservoir 12 containing the bath 11 and the solid support 10 remote from the latter, so as to obtain in the reservoir 12 an almost horizontal diffusion of the water.

When the solvent used is a solvent that is not miscible with water, the bath 11 is put in the presence of saturated water vapour.

Whatever the method employed, this putting of the bath 11 in contact with the water gives rise to a gradual change in the polarity of the bath, which triggers the self-assembly of a second layer of copolymer on the monolayer fixed to the solid support 10. More precisely, the hydrophobic blocks 22 of the copolymer molecules free in the bath 11 assemble on the hydrophobic blocks 22 of the copolymer molecules constituting the monolayer fixed to the solid support 10.

Through the control of the operating parameters, it is advantageously possible to precisely control the characteristics of this second layer. Furthermore, good homogeneity of the second layer results from the gradual nature of the change in polarity of the medium.

At the same time there also form, but in much smaller proportions, copolymer micelles 14 free in the bath 11.

At the end of the self-assembly step c), as indicated at 32 in FIG. 1, a final rinsing step d) is carried out. This last step aims to eliminate the copolymer vesicles or micelles 14, as well as any aggregates, in solution, by a gradual replacement of the solvent of the bath 11 with water. Thus, as indicated at 13 in FIG. 1, water is added to the reservoir 12, at the same time as aspiration of the liquid contained therein is carried out, as indicated at 15 in FIG. 1.

At the end of this last step, an ultra-fine dual-layer membrane 16 is obtained on the solid support 10, with a thickness of less than 50 nm, and with controlled characteristics, provided with free hydrophilic functions on the surface.

The organic solvent removed from the reservoir 12 can be recycled with a view to subsequent reuse thereof.

The steps described above can be reiterated as many times as required, so as to form, one after another, successive layers of copolymer on the solid support, by successive variations in polarity of the medium, each dual layer formed being protected before forming the following dual layer.

The method according to the invention can be implemented in a similar manner for forming asymmetric dual-layer membranes, that is to say in which the two layers are formed differently from one another.

Thus, at the end of step al) in which the amphiphilic block copolymer 20 is attached to the solid support 10, the bath 11 in which this solid support is immersed may be replaced, in an intermediate step b), by a bath containing a different amphiphilic block copolymer, in solution in an organic solvent in which it has a high degree of solubility. This organic solvent may be identical or different to the one used in the first bath 11.

The following steps of the method according to the invention can then be implemented in the same way as described previously, to obtain an asymmetric dual-layer membrane, with perfectly controlled characteristics, in particular in terms of thickness of each of the layers and orientation of the blocks present at the surface thereof.

### EXAMPLES

### Equipment and Methods

The silicon plates come from the company Silicon Inc. Silica quartz crystal plates (14 nm in diameter) with a resonant frequency of 5 MHz are used for the QCM experiments.

The products (3-aminopropyl)triethoxysilane (APTES, 99%), anhydrous toluene (99.9%), N,N-dimethylformamide (DMF, 99.8%), tetrahydrofuran (THF, 98.9%), dioxane (99.8%), 4-nitrobenzaldehyde (98%) and dodecane (99%)) come from Sigma-Aldrich.

The block copolymers PS(42 kg/mol)-b-PAA(4.5 kg/mol) and PS(42 kg/mol)-b-POE(11.5 kg/mol) come from Polymer Source Inc. Each of them has a polydispersity index of less than 1.1.

The buffered aqueous solutions: 0.1M KCl/HCl (pH 1-2), acetate buffer at 0.1M (pH 3.5-5.5), phosphate buffer at 0.1M (pH 6-7.5), sodium carbonate buffer at 0.1M (pH 9-10), sodium phosphate 0.1M (pH 11), 0.1M (KCl/NaOH (pH 12-13) were used for dosing with two liquids via wetting.

Two Bioseb programmable syringe drivers, PTFE filters with pore sizes 20 nm, 0.1 μm and 0.2 μm coming from GE Healthcare Life Sciences and Nalgene were used. Deionised water was used for preparing the solutions.

Determination of the Grafting Density of the Amine Functions on the Surface of the Silica Plate

The plates functionalised by APTES are immersed for hours at 50° C. in a solution of absolute ethanol containing 0.08% vol. acetic acid and 0.05% by mass 4-nitrobenzaldehyde. After rinsing with ethanol in order to eliminate the excess 4-nitrobenzaldehyde, the plates were immersed in an aqueous solution of acetic acid at 0.15% for 1 hour. The concentration of 4-nitrobenzaldehyde is determined by UV-visible spectroscopy at 268 nm. This then makes it possible to determine the surface density of amine groups.

Ellipsometry Ellipsometry measurements are carried out at between 300 and 800 nm for three different angles (65°, 70°, 75°, with a UVISEL (Horiba Scientific) ellipsometer. To establish the model, the values n=3.86, k=0.2 for the silica and n=1.46, k=0 for an organic film, are used.

Tensiometry—Determination of Contact Angle

The wetting measurements are carried out in air using a TRACKER tensiometer (Teclis Scientific). A drop of water (with a volume of 2 μl) is deposited by means of a syringe on the surface covered with a thin film. The detection of the contact angle is carried out continuously by means of a CCD camera connected to the control and analysis software. This measurement is determined by modelling the form of the drop using the Laplace equation: ΔP=2γ/R. Monitoring of the evaporation of the drop of water over time makes it possible to determine the natural dewetting angle of the surface. The advancement angle (maximum), the withdrawal angle (minimum) and the hysteresis are then to be determined.

Atomic Force Microscopy (AFM)

The measurements are carried out in contact mode intermittently, in air and at ambient temperature, on ICON instrumentation (Bruker) equipped with a J-type scanner with a maximum analysis surface area of 100×100 μm² and a limit height of 13 μm. The images are analysed with WsxM software.

Quartz Crystal Microbalance with Dissipation (QCM-D-Q-Sense Biolin Scientific)

The kinetic monitoring of the in situ formation of a dual layer of block copolymers is carried out in a liquid cell of a quartz microbalance. QCM supports (Biolin Scientific) covered with a layer of silica previously functionalised with a monolayer of APTES are used.

Dynamic Diffusion of Light

The size and polydispersity of the suspensions of silica nanoparticles are determined before/after self-assembly of a dual layer of copolymer on the surface of the nanoparticles by dynamic diffusion of light at 90°, by means of an ALV system equipped with an ALV-5000/E correlator.

### Example 1—Polystyrene-Block-Polyacrylic Acid Diblock Copolymer

The polystyrene-block-polyacrylic acid diblock copolymer, designated PS-b-PAA, of formula:

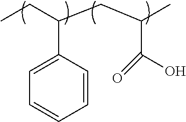

comprises a hydrophobic polystyrene block with a number mean molar mass Mn=42 kg/mol greater than its intergrowth critical mass (Mc=32 kg/mol), and a hydrophilic polyacrylic acid block with a number mean molar mass Mn=4.5 kg/mol.

The polystyrene block (PS) has a hydrophobicity characterised by an interface tension with the water γ_{PS/water}=32 mN/m, and a glass transition temperature of 100° C. The hydrophilic polyacrylic acid block (PAA) offers the possibility of participating in various types of bond with the substrate (acid-base or electrostatic, chelation). In this example, the interaction by acid-base is more particularly studied.

1.1) Preparation of the Substrate

The solid support used is a flat plate (1×2 cm²) of silicon having on the surface a fine layer of native silicon oxide (silica SiO₂), a few nanometres thick. To allow the formation of non-covalent interactions between this plate and the hydrophilic block of type PAA, a functionalisation of the substrate is necessary.

The silica plate is functionalised in a way that is conventional in itself, by an aminosilane (3-aminopropyltriethoxysilane APTES), in order to form on its surface a thin film comprising primary amine functions —NH₂. To this end, the silica plate is irradiated with UV-ozone in order to obtain reactive hydroxyl groups (—OH) on the surface. The plate is next immersed for 1 hour in a 2% solution by mass of 3-aminopropyltriethoxysilane (APTES) in anhydrous toluene. The substrate is then rinsed with anhydrous toluene and stoved for 1 hour at 95° C.

The presence of the surface amine functions is verified by measurements of contact angle at various pH levels. The surface density of amine functions is determined by spectroscopic analysis with 4-nitrobenzaldehyde in accordance with a method described in the literature (Ho Moon et al. Langmuir, 1996, 12, 4621-4624). A surface density of 31.4 Å²/molecule is obtained. Analysis of the surface amine functions by measurement of contact angle at various pH levels reveals that the pKa of the amine functions is −6.5.

1.2) Formation of a Copolymer Monolayer on the Support

The absorption on the solid support is effected in solution in a mixture of dimethylformamide DMF and tetrahydrofuran THF. This non-polar mixture is non-selective for the copolymer, both the hydrophilic block and the hydrophobic block having good solubility therein.

The polystyrene-block-polyacrylic acid copolymer having a PS block of 42000 g/mol (DP=404) and a PAA block of 4500 g/mol (DP=63) (PS₄₀₃-b-PAA₆₃) is dissolved at 1 g/l in a DMF/THF mixture (80/20 (v/v). The aminated silica plate is immersed for 2 hours in the copolymer solution previously filtered over a 0.1 μm membrane.

The substrate is next rinsed with a DMF/THF mixture (80/20) (v/v) and dried for 2 days under a hood.

A monolayer of PS-b-PAA is formed, securely anchored to the surface of the solid support. This monolayer is characterised by measurement of contact angle, ellipsometry and AFM. The adsorption method is also monitored by means of a quartz crystal microbalance (QCM-D), which makes it possible to determine the quantity of copolymer adsorbed in the monolayer. It is determined that the layer of PS-b-PAA adsorbed on the solid support has a thickness of 5.8 nm, a contact angle θ_{A}=91° and a hysteresis value Δθ=12°.

The results of the analyses carried out are shown in FIG. 2. More particularly, for the QCM-D analysis (FIG. 2a), the appearance of an adsorption plateau as from a copolymer concentration of approximately 10×10⁻⁶ mol/1 (0.1 g/l) is noted, with a grafting density Γsat equal to approximately 10 mg·m⁻². By analysis by AFM (FIG. 2b)) the appearance of islets resulting from the reorganisation of the chains when passing the good solvent/air interface is clearly observed. Analysis of the distribution of the heights of the copolymer islets on the surface (FIG. 2c)) for its part shows a thickness of the monolayer of approximately 5 nm, in agreement with the ellipsometry measurements.

The results of the analyses carried out show that the copolymer monolayer is homogeneous and has a thickness of around 5 nm. The formation of islets observed in AFM corresponds to a dewetting phenomenon occurring on the surface of the film when the latter passes through the water-air interface. From the adsorption isotherm, it is possible to calculate a grafting density of 0.15 copolymer chains/nm², which is in good agreement with a conformation regime of the “brush” type obtained since the interchain separation distance is less than the size of the copolymer chain itself.

1.3) Formation of a Symmetrical Dual Layer by Switching of Solvent

At the end of the step of immersion of the aminated silica plate for 2 hours in the previously filtered copolymer solution, as indicated above, water is added to the copolymer solution, which has an initial volume of 2 ml, in order to trigger self-assembly. This addition is carried out so as to obtain, above the solid support, a solvent height of between 2 and 3 nm. More precisely, the water is added to the copolymer solution at a rate of 0.3 ml/min using a syringe driver.

After 15 minutes, a proportion by volume of water in the bath of 49% has been obtained; while maintaining the injection of water, the solution is then pumped by means of another syringe driver, at a rate of 0.3 ml/min.

The simultaneous steps of injecting water and pumping the solution make it possible to eliminate the micelles/vesicles of self-assembled copolymers in solution while completely exchanging the initial organic solution for water.

After 2 hours of simultaneous injection and aspiration, the entire organic solution has been exchanged for pure water. The support is removed and put to dry under a hood for 1 day. A symmetrical dual-layer membrane has formed on its surface.

The dual layer thus self-assembled is characterised by contact angle measurement and ellipsometry. Its thickness measured by ellipsometry is 11 nm, that is to say approximately twice the thickness of its first layer (5.8 nm). The contact angle θ_{A} measured in air at pH=7 is 91° with a hysteresis Δθ=31°.

Dosing with two liquids is carried out in order to demonstrate the presence of the PAA blocks at the tops and to reveal the hydrophobic effect of the PS block. It makes it possible to define a pKa of 5.53 for the carboxylic acid group on the surface.

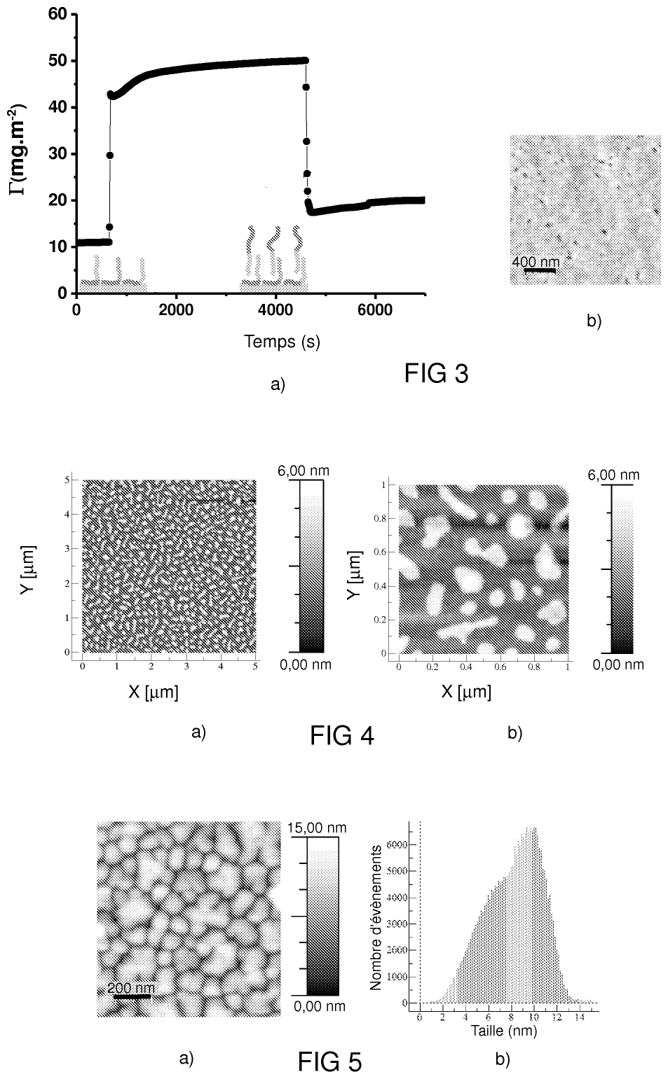

Furthermore, during the implementation of these steps, QCM-D analyses of the solid support are carried out, at regular time intervals. The dual layer finally obtained is further analysed by AFM. The results obtained are shown in FIG. 3. More particularly, FIG. 3a) shows the change in the quantity of adsorbed copolymer Γ as a function of time. FIG. 3b) shows the image, obtained by AFM, of the self-assembled dual layer on the solid support.

As can be seen in this figure, in the first step of the method, a monolayer forms on the aminated surface of the substrate, with a density of approximately 10 mg·m⁻² (which is in agreement with the adsorption isotherm in FIG. 2a)). In the second step, in which the solvent mixture is gradually replaced with water, a second monolayer forms on the surface, with a density of 10 mg·m². The dual layer thus formed has a final density of approximately 20 mg·m², that is to say twice the density of a monolayer. As can be seen in FIG. 3b), it has a smooth surface morphology, representative of the surface covered with PAA chains, more hydrophilic than those of PS. The total thickness of the dual layer is 10 nm.

### Example 2—Polystyrene-Block-Polyethylene Oxide Diblock Copolymer

The polystyrene-block-polyethylene oxide diblock copolymer, designated PS-b-POE, of formula:

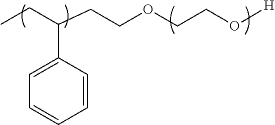

offers the possibility of forming hydrogen bonds with the substrate.

The copolymer used consists of a hydrophobic polystyrene block with a number mean molecular mass Mn=42 kg/mol and a hydrophilic polyethylene oxide block with a number mean molecular mass Mn=11.5 kg/mol.

2.1) Preparation of the Substrate

The solid support used is a flat silicon plate (1×2 cm²) having on the surface a fine layer of native silicon oxide (silica SiO₂), a few nanometres thick. To allow the formation of non-covalent interactions (hydrogen bonds) between this plate and the hydrophilic block of type POE, an ultraviolet-ozone treatment is carried out to introduce hydroxyl groups (—OH) on the surface of the plate.

2.2) Formation of a Copolymer Monolayer on the Support

The solvent used is toluene. This non-polar solvent is non-selective for the copolymer, both the hydrophilic block and the hydrophobic block having good solubility therein.

The polystyrene-block-polyethylene oxide copolymer having a PS block of 42000 g/mol (DP=404) and a POE block of 11500 g/mol (DP=261) (PS₄₀₃-b-POE₂₆₁) is dissolved at 1 g/l in toluene.

The oxidised silicon plate (SiOH) is immersed for 2 hours in the copolymer solution previously filtered on a 0.1 μm membrane. The support is next rinsed with toluene and dried for 2 days under a hood.

A monolayer of PS-b-POE has formed, firmly anchored to the surface of the solid support. This monolayer is characterised by contact angle measurement, ellipsometry and AFM. The thickness of the monolayer formed, determined by ellipsometry, is 4.49 nm. This value is in agreement with the size of the copolymer in the toluene. It is relatively low, probably since the copolymer adopts a conformation of the “mushroom” type, because of the molar mass of the POE block, which is relatively high. Under these conditions, the PS block spreads more.

The measured contact angle is θ_{A}=46.7° with a hysteresis Δθ=13.7°.

The AFM images obtained, at various magnifications, are shown in FIG. 4. They confirm the adsorption of the POE-PS copolymers, from the toluene solution, on the silica surface, through hydrogen bonds formed between the POE block and the surface silanol groups. Because of the use of a POE block with a relatively high molar mass, the grafting density obtained is relatively low, which is illustrated by the presence of islets of PS spaced apart from each other. The use of POE with a lower molar mass makes it possible to increase the grafting density of the monolayer. Thus the grafting density can easily be adjusted by selecting a copolymer the hydrophilic block of which has a suitable molar mass.

2.3) Formation of a Symmetrical Dual Layer by Switching Solvent

At the end of the step of immersing the oxidised silica plate for 2 hours in the copolymer solution as indicated above, self-assembly is triggered.

To this end, the copolymer solution is put in the presence of saturated water vapour generated by a hot-water reservoir (at approximately 50° C.) placed in the vicinity of the system, the whole under a hermetic bell so as to saturate the atmosphere above the solution with vapour.

The system is next rinsed by the injection of water while aspirating the non-miscible toluene. After 2 hours, the support is removed and set to dry under a hood for 2 days.

A self-assembled asymmetric dual layer is obtained on the solid support.

### Example 3—Formation of PS-b-PAA and PS-b-POE Asymmetric Dual Layer

A PS-b-PAA monolayer is formed as in example 1.2) above. The self-assembly of this monolayer is next carried out with a second block copolymer (PS-b-POE), comprising a hydrophilic block that is different but a hydrophobic block that is identical to that of the monolayer.

To this end, at the end of this step of immersion of the aminated silica plate for 2 hours in the copolymer solution, as indicated above, the DMF/THF mixture (80/20) is replaced by a polystyrene-block-polyethylene oxide copolymer solution having a PS block of 42000 g/mol (DP=404) and a POE block of 11500 g/mol (DP=261) (PS₄₀₃-b-POE₂₆₁) at 1 g/l in toluene, the solvent in which the copolymer is best solubilised. Prior to this, the solid support was rinsed with the organic solvent of the first layer (DMF/THF), in order to discharge the non-adsorbed block copolymers in solution.

The self-assembly of the dual layer is next triggered by putting the copolymer solution in the presence of saturated water vapour generated by a hot-water reservoir (at approximately 50° C.) placed in the vicinity of the system, the whole under a hermetic bell for 4 hours.

The system is next rinsed by injecting water while aspirating the non-miscible toluene, at injection and aspiration rates each of 0.3 ml/min. After 2 hours, the support is removed and set to dry under a hood for 2 days.

The asymmetric dual layer thus self-assembled is characterised by contact angle measurement, ellipsometry and AFM. The macroscopic thickness thereof measured by ellipsometry is 17 nm. The wetting angle values at a relatively low advance θ_{A}=82° and a hysteresis Δθ=22° are consistent with the formation of a dual layer with POE on the surface.

As shown by the image obtained by AFM, shown in FIG. 5, the dual layer has a mushroom-type structure. This is due to the presence of the POE blocks on the surface of the membrane, which have a high molar mass, and which will collapse when passing through the water/air interface.

The structure, with a roughness of 2.43 nm, has holes with a maximum depth of 15.4 nm and a mean thickness of the surface objects of 8.36 nm (as shown by the height distribution graph shown in FIG. 5b)). These data demonstrate the formation of a dual layer with a mean thickness for the PS-b-POE layer of 8.36 nm and a total thickness of approximately 16 nm, in agreement with ellipsometry measurements.

### Example 4—Self-Assembly on the Surface of Nanoparticles

The previous three examples, carried out on microscopic flat surfaces of oxidised silica (SiOH) and aminated silica (—NH₂) are transposed on silica nanoparticles (diameter 200 nm), both in oxidised form and in aminated form.

At the end of the addition of water, in liquid form or in vapour form depending on the organic solvents used, the particles are centrifuged, the supernatant is eliminated and water is added to wash the particles. This procedure is repeated at least once more in order to eliminate the entire free polymer in solution as well as the residual traces of solvent.

The sizes of the silica nanoparticles are measured by dynamic diffusion of light before and after self-assembly of the copolymer dual layer. The difference in size makes it possible to measure the thickness of the membrane formed on the surface of the particles. This is typically between 15 and 30 nm.

### Example 5—Encapsulation of Gold Nanoparticles in a Dual-Layer Membrane Formed Based on Polystyrene-Block-Polyacrylic Acid Diblock Copolymer

The copolymer used in this example is a polystyrene-block-polyacrylic acid diblock copolymer, designated PS₄₀₃-b-PAA₆₃, having a PS block of 42000 g/mol (DP=404) and a PAA block of 4500 g/mol (DP=63). The solid support is a flat silicon plate functionalised as described in example 1.1).

A monolayer of PS₄₀₃-b-PAA₆₃ is generated on the solid support as described in example 1.2).

A solution of PS₄₀₃-b-PAA₆₃ at 1 g/l and hydrophobic gold nanoparticles (NP) (diameter˜3-4 nm) at 1×10⁶ NP/l in a dimethylformamide/tetrahydrofuran (DMF/THF) mixture (80/20) (v/v) is also prepared. This solution is added to the receptacle containing the PS₄₀₃-b-PAA₆₃ monolayer. Water is next added to this copolymer/nanoparticle hybrid solution, which has an initial volume of 3 ml, in order to trigger self-assembly as described in example 1.3), so as to produce a symmetrical dual-layer membrane. This addition is carried out at a rate of 0.3 ml/min using a syringe driver, so as to obtain, above the solid support, a solvent height of between 3 and 4 mm.

After 15 minutes, a proportion of water by volume in the bath of 49% is obtained; while maintaining the injection of water, the solution is then pumped by means of another syringe driver, at a rate of 0.3 ml/min.

During these operations, the gold nanoparticles are encapsulated inside the dual-layer membrane generated on the support, as well as in the micelles formed in volume. The simultaneous steps of injecting water and pumping the solution eliminate these hydride micelles of self-assembled copolymers in solution, while completely exchanging the initial organic solution for water. After 2 hours of simultaneous injection and aspiration, the entire organic solution has been exchanged for pure water. The support is removed and set to dry under a hood for one day.

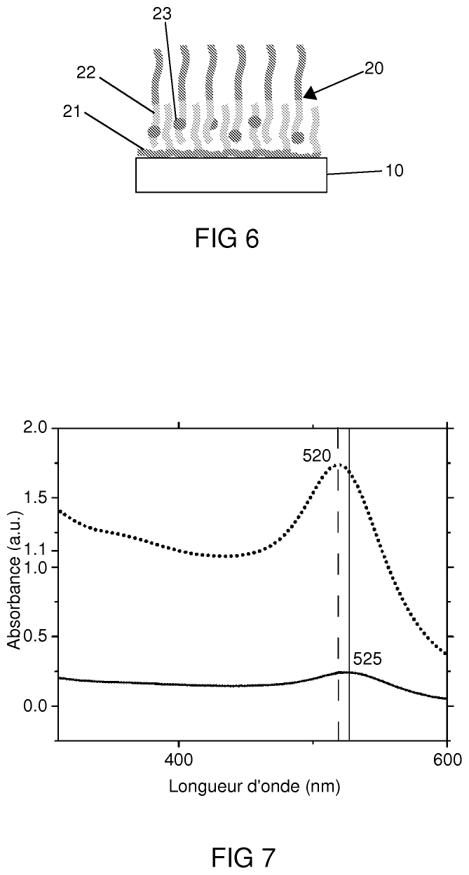

At the end of this method, as shown in FIG. 6, on the surface of the solid support 10, a symmetrical dual-layer membrane is obtained, formed from the amphiphilic block copolymer 20 and containing gold nanoparticles 23 encapsulated in the hydrophobic reservoir formed by the hydrophobic polystyrene blocks 22.

The dual layer thus self-assembled is characterised by contact angle measurement and ellipsometry as described in example 1. Its thickness measured by ellipsometry is 13 nm, that is to say a little more than twice the thickness of its first layer (5.8 nm). The contact angle θ_{A} measured in air at pH=7 is 89° with a hysteresis Δθ=35°.

The solid support covered with this dual-layer membrane containing gold nanoparticles is then characterised by conventional UV-visible transmission spectroscopy. As shown in FIG. 7, the hydrophobic gold nanoparticles have, in the hydrophobic polystyrene reservoir, a characteristic plasmon signature, at approximately 525 nm, suggesting a successful encapsulation (continuous black curve). The broken black curve for its part represents the gold nanoparticles in solution (in the THF/DMF mixture) with their characteristic plasmon peak at around 520 nm. The difference in absorption between these two curves results from a different detected volume in solution (50 mm bowl) and in the dual-layer membrane (approximately 35 nm). The slight displacement in wavelength results from the change in dielectric environment of the nanoparticles in passing from the solution (THF/DMF) to the dual-layer membrane.

1. Method for manufacturing a membrane from at least one amphiphilic block copolymer, referred to as the first amphiphilic block copolymer, comprising at least one hydrophilic block and at least one hydrophobic block,
said method comprising successive steps of:
a) immersing a support comprising functions able to form a bond with said hydrophilic block in a first bath containing said first amphiphilic block copolymer in solution in an organic solvent in which said hydrophilic block and said hydrophobic block are soluble, for a sufficient period to enable the formation of bonds between said hydrophilic block and said support, and the immobilisation of a first layer of said first amphiphilic block copolymer on the surface of said support;
b) when appropriate, replacing said first bath with a second bath containing a second amphiphilic block copolymer comprising at least one hydrophilic block and at least one hydrophobic block, in solution in an organic solvent in which the hydrophilic block and the hydrophobic block of the second amphiphilic block copolymer are soluble;
c) and adding water to the bath containing said support on the surface of which said first layer is immobilised, the addition of water causing the self-assembly of a second layer of amphiphilic block copolymer on said first layer.

2. Method according to claim 1, comprising, after the step c) of adding water to the bath, a step d) of rinsing the support and layers of amphiphilic block copolymer with an aqueous solution.

3. Method according to claim 2, wherein the rinsing step d) comprises the gradual replacement of the organic solvent contained in the bath with water.

4. Method according to claim 1, wherein the step c) of adding water to the bath comprises the gradual introduction of a liquid aqueous solution in said bath.

5. Method according to claim 4, wherein the gradual introduction of a liquid aqueous solution in the bath is carried out at a rate making it possible to obtain an increase in the quantity of water in the bath of less than or equal to 50% by volume, with respect to the total volume of the bath, per minute.

6. Method according to claim 4, wherein the gradual introduction of a liquid aqueous solution in the bath is carried out until a quantity of water is obtained in the bath of between 5% and 50% by volume with respect to the total volume of the bath.

7. Method according to claim 1, wherein step c) of adding water to the bath comprises putting the bath in contact with saturated water vapour.

8. Method according to claim 7, wherein putting the bath in contact with saturated water vapour is carried out for a period of between 10 and 180 minutes.

9. Method according to claim 1, wherein step a) of immersing the support in the first bath is carried out for a period of between 10 and 180 minutes.

10. Method according to claim 1, wherein the first bath contains said first amphiphilic block copolymer at a concentration of between 0.01 and 10 g/l in said organic solvent.

11. Method according to claim 1, wherein the second bath contains said second amphiphilic block copolymer at a concentration of between 0.01 and 10 g/l in said organic solvent.

12. Method according to claim 1, wherein the first amphiphilic block copolymer (20), and when appropriate the second amphiphilic block copolymer, is a diblock copolymer or a triblock copolymer.

13. Method according to claim 1, wherein the hydrophobic block of the first amphiphilic block copolymer, and when appropriate of the second amphiphilic block copolymer, is chosen from the group consisting of hydrophobic polystyrenes, polyacrylates, polydienes, polylactones, polylactides, polyglycolides, polyolefins, polyoxiranes, polysiloxanes, polyacrylonitriles, vinyl polyacetates, polytetrahydrofuran, polyhydroxyalkanoates, polythiophenes, hydrophobic polypeptides, and polycarbonates.

14. Method according to claim 1, wherein the hydrophilic block of the first amphiphilic block copolymer, and when appropriate the hydrophilic block of the second amphiphilic block copolymer, is chosen from the group consisting of polyacrylic acids, polyacrylamides, polyethers, polystyrene sulfonic acids, polyvinyl alcohols, poly(2-vinyl N-methyl pyridinium), poly(4-vinyl N-methyl pyridinium), polyamines, hydrophilic polypeptides, polyoxazolines, polysaccharides, polyureas, zwitterionic polymers, or any of the salts thereof.

15. Method according to claim 1, wherein the organic solvent of the first bath, and when appropriate the organic solvent of the second bath, is chosen from the group consisting of tetrahydrofuran, dimethyl sulfoxide, dimethylformamide, dimethylacetamide, acetonitrile, dioxane, acetone, ethylene glycol, methanol, pyridine, N-methyl-2-pyrrolidone, toluene, dichloromethane, chloroform, xylene, hexafluoroisopropanol, or any of the mixtures thereof.

16. Method according to claim 1, wherein the support is formed from a material chosen from the group consisting of ceramics, glasses, silicates, polymers, graphite and metals.

17. Membrane obtainable by a method according to claim 1, comprising a first layer of an amphiphilic block copolymer immobilised on a support, and a second layer of an amphiphilic block copolymer fixed to said first layer by hydrophobic interaction.

18. Method according to claim 2, wherein the step c) of adding water to the bath comprises the gradual introduction of a liquid aqueous solution in said bath.

19. Method according to claim 3, wherein the step c) of adding water to the bath comprises the gradual introduction of a liquid aqueous solution in said bath.

20. Method according to claim 5, wherein the gradual introduction of a liquid aqueous solution in the bath is carried out until a quantity of water is obtained in the bath of between 5% and 50% by volume with respect to the total volume of the bath.
